(19) United States
(12) Patent Application Publication
(10) Pub. No.: US 2026/0023597 A1
(43) Pub. Date: Jan. 22, 2026

(54) COMPUTER-READABLE RECORDING MEDIUM HAVING STORED THEREIN JOB MANAGEMENT PROGRAM, JOB MANAGEMENT METHOD, AND INFORMATION PROCESSING APPARATUS

(71) Applicant: Fujitsu Limited, Kawasaki-shi (JP)

(72) Inventor: Hiroki OHTSUJI, Yokohama (JP)

(73) Assignee: Fujitsu Limited, Kawasaki-shi (JP)

(21) Appl. No.: 19/237,079

(22) Filed: Jun. 13, 2025

(30) Foreign Application Priority Data
Jul. 22, 2024 (JP) 2024-117224

(51) Int. Cl. G06F 9/48

(52) U.S. Cl. CPC G06F 9/4881

(57) ABSTRACT

A computer-readable recording medium having stored therein a Job management program causes a computer to execute a process includes: obtaining, for each of jobs submitted to a system including computing nodes, a number setting of nodes configured to be used for an execution of the each job; determining whether the number setting of nodes is smaller than or equal to a threshold; increasing, for at least a part of one or more jobs of which number setting of nodes is smaller than or equal to the threshold, a number of the computing nodes used for the execution; and causing at least a part of the computing nodes to execute the jobs by switching between the jobs at divided time intervals while maintaining data of the jobs stored in a distributed manner in a memory in each node of the computing nodes in the system.

### CROSS-REFERENCE TO RELATED APPLICATION

This application is based upon and claims the benefit of priority of the prior Japanese Patent application No. 2024-117224, filed on Jul. 22, 2024, the entire contents of which are incorporated herein by reference.

### FIELD

The embodiment discussed herein relates to a computer-readable recording medium having stored therein a job management program, a job management method, and an information processing apparatus.

### BACKGROUND

A computer system is known that includes computers, each having a processor and a memory, as computing nodes, such that the plurality of computing nodes operate in coordination to perform computations.

The time slice execution technique is known in which a plurality of jobs are executed in parallel, i.e., executed in a time-division manner in a system having a plurality of computing nodes in order to efficiently utilize the plurality of computing nodes. In time slice execution, data of a plurality of jobs is temporarily stored in a distributed manner in the memory of each computing node.

For example, related art is disclosed in Japanese Laid-open Patent Publication No. 2023-164156.

### SUMMARY

According to an aspect of embodiments, a non-transitory computer-readable recording medium having stored therein a job management program that causes a computer to execute a process includes: obtaining, for each of the plurality of jobs submitted to a system including a plurality of computing nodes, a number setting of nodes configured to be used for an execution of the each job; determining whether or not the number setting of nodes is smaller than or equal to a threshold; increasing, for at least a part of one or more jobs of which number setting of nodes is smaller than or equal to the threshold, a number of the computing nodes used for the execution within a total number of computing nodes in the system; and causing at least a part of the plurality of computing nodes to execute the plurality of jobs by switching between the plurality of jobs at divided time intervals while maintaining data of the plurality of jobs stored in a distributed manner in a memory in each node of the plurality of computing nodes in the system.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating an example of the hardware (HW) configuration of a computing system according to one embodiment;

FIG. 2 is a block diagram illustrating an example of the hardware configuration of a computing node illustrated in FIG. 1;

FIG. 3 is a block diagram illustrating an example of the hardware configuration of a computer;

FIG. 4 is a diagram illustrating an example of the execution state of jobs in non-time slice execution;

FIG. 5 is a diagram illustrating an example of the execution state of jobs in time slice execution according to a comparative example;

FIG. 6 is a diagram illustrating an example of switching of jobs in time slice execution;

FIG. 7 is a diagram illustrating one example of the execution state of jobs in time slice execution in an embodiment of the present disclosure;

FIG. 8 is a diagram illustrating another example of the execution state of jobs in time slice execution in an embodiment of the present disclosure;

FIG. 9 is a diagram illustrating the relationship between the number of computing nodes executing jobs and memory usage;

FIG. 10 is a diagram illustrating one example of a signal transmission process for time slice execution;

FIG. 11 is one example of a correspondence table that associates job IDs with process IDs in each computing node;

FIG. 12 is a diagram illustrating experimental results regarding the effect of time slice execution on processing time;

FIG. 13 is a block diagram illustrating an example of the functional configuration of the login server illustrated in FIG. 1;

FIG. 14 is a flowchart illustrating one example of a job management process in an embodiment of the present disclosure;

FIG. 15 is a flowchart illustrating one example of the process when the number setting of nodes is one in an embodiment of the present disclosure; and

FIG. 16 is a diagram illustrating one example of a performance characteristic.

### DESCRIPTION OF EMBODIMENT(S)

When a plurality of jobs are executed in parallel in a system having a plurality of computing nodes, the amount of storage space of the memory (hereinafter sometimes referred to as “memory usage”) used in each computing node increases. If the memory usage in a computing node exceeds the available storage capacity (hereinafter sometimes referred to as “memory capacity”) of the memory provided in the computing node, memory shortage occurs. If memory shortage occurs, a memory swap operation is performed to exchange data between an area in the memory and an equally sized area in an external storage device, potentially leading to a decrease in system performance.

Hereinafter, the embodiments of the present disclosure will be described with reference to the accompanying drawings. However, the embodiments described below are merely illustrative and are not intended to exclude the application of various modifications and techniques not explicitly described below. For example, the present embodiment can be variously modified and implemented without departing from the scope thereof. In the drawings to be used in the following description, like reference numbers designate the same or substantially same parts and elements, unless otherwise specified.

### (A) Example of Hardware Configuration in One Embodiment

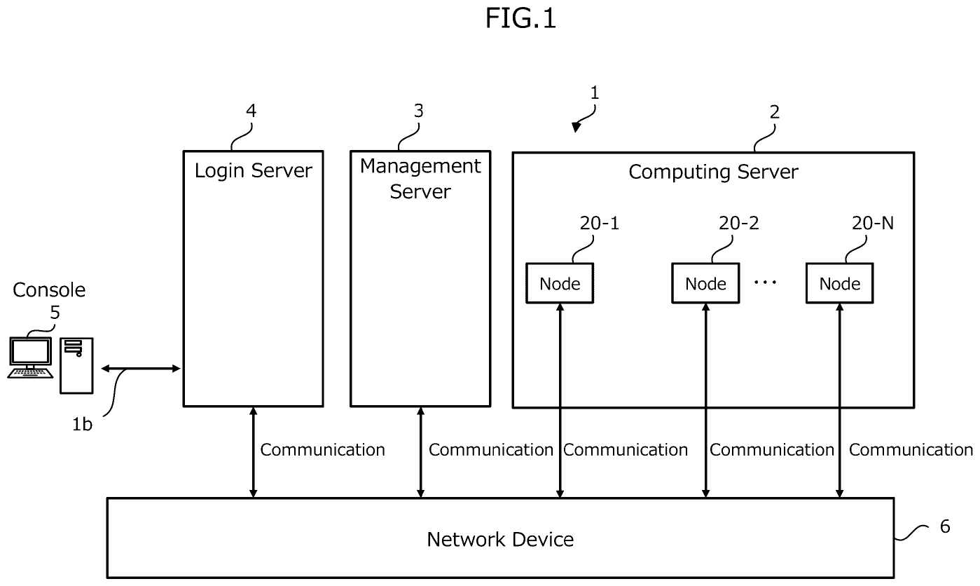

FIG. 1 is a block diagram illustrating an example

of the hardware (HW) configuration of a computing system 1 according to one embodiment.

As illustrated in FIG. 1, the computing system 1 may include, as an example, a computing server 2, a management server 3, a login server 4, a console 5, and a network device 6.

The computing server 2 executes computations assigned to the computing server 2. The computing server 2 may be, for example, a computer system that achieves the function of High Performance Computing (HPC). The computing server 2 includes a plurality of computing nodes 20-1 to 20-N (where N represents the number of computing nodes) that are communicatively connected to each other, and is configured to cause these plurality of computing nodes 20-1 to 20-N (hereinafter sometimes referred to as computing nodes 20) to operate in coordination to perform computations. The computing server 2 may include, for example, several thousand or more computing nodes 20.

Each computing node 20 is one example of a computer or computing machine that includes a processor and a memory. Each computing node 20 may be connected to the network device 6. The network device 6 may be a network switch, which may be, for example, a Layer 2 switch (L2 switch) or the like. The network switch may be configured in multistage interconnection. The plurality of computing nodes 20 may configure an indirect network computer where the computing nodes 20 are primarily connected via the network device 6. In other words, each computing node 20 may function as a server. However, the computing server 2 is not limited to an indirect network computer. For example, the plurality of computing nodes 20 may be connected via a direct connection network, and various modifications may be embodied. A program for performing computations assigned to the computing server 2 is executed by one or more computing nodes 20, and when the program is executed by a plurality of computing nodes 20, the computation contents are communicated among the computing nodes 20 via the network device 6 to obtain computation results.

The management server 3 is one example of a computer or information processing apparatus that manages the execution order of a plurality of jobs (programs) to be executed by the computing server 2, and computer resources. The management server 3 executes a job scheduler. The job scheduler may be, for example, Slurm. However, the job scheduler is not limited to Slurm.

The login server 4, in response to being accessed by a user, verifies the identity of the user and, if the login server 4 determines that the user is an authentic user, it authorizes the user to use the system.

The console 5 is a terminal apparatus operated by the user to perform computations on the computing server 2 and is one example of a computer. The console 5 is connected to the login server 4 via a network 1b. It should be noted that the computing system 1 may include a plurality of consoles 5.

In the present embodiment, the user logs into the login server 4 via the network 1b by operating the console 5. For example, the user submits a job to be executed on the computing server 2 via the console 5. The console 5 sends a program, a job script, and the like related to the job to be executed on the computing server 2, to the login server 4.

The login server 4 receives the program, the job script, and the like from the console 5. As a result, the job is submitted to the computing system 1. The login server 4 executes a process to increase the number of nodes in the arguments in the program and the job script. The login server 4 sends the program, the job script, and the like reflecting the increased number of nodes, to the management server 3. This process will be described later.

The login server 4, the management server 3, and the computing server 2 may be connected to achieve high-speed communications via the network device 6.

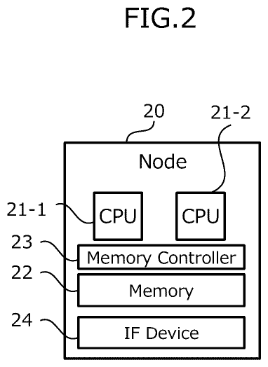

FIG. 2 is a block diagram illustrating an example of the hardware configuration of the computing node 20 illustrated in FIG. 1. The computing node 20 includes Central Processing Units (CPUs) 21-1 and 21-2 (hereinafter sometimes referred to as CPUs 21), a memory 22, a memory controller 23, and an IF device 24.

Each CPU 21 is one example of a processing unit that performs various controls and computations. The CPUs 21 may execute jobs.

The memory 22 is one example of HW that stores information such as various data and programs, and is one example of a main storage device (main memory). Examples of the memory 22 include either or both of volatile memory, such as a Dynamic Random Access Memory (DRAM), and non-volatile memory, such as a Persistent Memory (PM), for example.

The memory controller 23 is a controller that controls accesses between the CPUs 21 and the memory 22 and is, for example, an integrated circuit (IC).

The IF device 24 is a communication device used for communications between the computing nodes 20.

In the computing system 1 including the plurality of computing nodes 20, data of a plurality of jobs is stored in a distributed manner in the memory 22 in each computing node 20. When the plurality of jobs are executed on at least a part of the plurality of computing nodes 20 while being switched at divided time intervals while the data of the plurality of jobs is stored in a distributed manner, memory shortage in the memories 22 is prevented by processing by the login server 4 or the like. The details of the processing will be described later.

Next, one example of the hardware configuration of the login server 4 illustrated in FIG. 1 will be described.

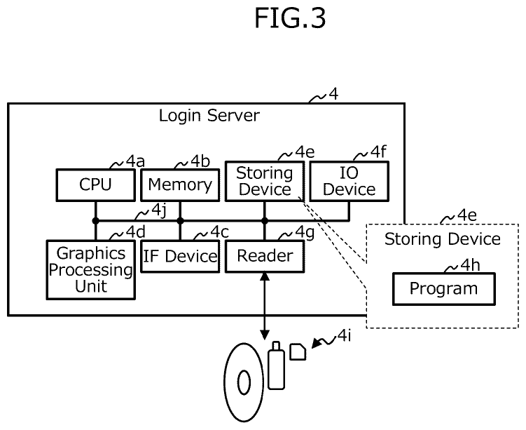

FIG. 3 is a block diagram illustrating an example of the hardware configuration of the login server 4. As illustrated in FIG. 3, the login server 4 may include, as an example, a CPU 4a, a memory 4b, an IF device 4c, a graphics processing unit 4d, a storing device 4e, an Input/Output (IO) device 4f, and a reader 4g, as an HW configuration.

The CPU 4a is one example of a processing unit or processor that performs various controls and operations. The CPU 4a may be communicably connected to each block in the login server 4 via a bus 4j. The CPU 4a may be a multiprocessor having a plurality of processors, may be a multicore processor having a plurality of processor cores, or may be configured to have a plurality of multicore processors.

Instead of the CPU 4a, a processor, such as an integrated circuit (IC), e.g., an MPU, APU, DSP, ASIC, or FPGA, may be provided, for example. It should be noted that a combination of two or more of these integrated circuits may be used as the processor. MPU is an abbreviation for Micro Processing Unit. APU is an abbreviation for Accelerated Processing Unit. DSP is an abbreviation for Digital Signal Processor, ASIC is an abbreviation for Application Specific IC, and FPGA is an abbreviation for Field-Programmable Gate Array.

The memory 4b is one example of HW configured to store information, such as various data and programs. Examples of the memory 4b include, for example, either or both of a volatile memory, such as a DRAM, and a non-volatile memory, such as a PM. The memory 4b is one example of a main storage device.

The IF device 4c is one example of a communication IF that performs controls, etc., on connections and communications between the computing nodes 20, the management server 3, the login server 4, and the console 5. The IF device 4c may include an adapter compliant with high-speed interconnects through the network device 6, etc., a Local Area Network (LAN) such as Ethernet®, or optical communications such as FC. This adapter may support either or both of wireless and wired communication methods.

It should be noted that the program 4h may be downloaded from a network to the login server 4 via the communication IF and stored in the storing device 4e.

The graphics processing unit 4d is one example of a processing unit that controls screen display on an output device, such as a monitor, of the IO device 4f. Additionally, the graphics processing unit 4d may be configured as an accelerator that executes various computations, such as machine learning processing and inference processing using machine learning models, for example. Examples of the graphics processing unit 4d include various processing units, such as integrated circuits (ICs), e.g., a Graphics Processing Unit (GPU), APU, DSP, ASIC, or FPGA.

The storing device 4e is one example of HW configured to store information, such as various data and programs. The storing device 4e may be used as a local storage for each of the computing nodes 20, the management server 3, the login server 4, and the console 5. Examples of the storing device 4e include various storing devices, such as magnetic disk devices, e.g., a Hard Disc Drives (HDD), semiconductor drive devices, e.g., a Solid State Drive (SSD), and a non-volatile memory. Examples of the non-volatile memory include a flash memory, a Storage Class Memory (SCM), and a Read Only Memory (ROM).

The storing device 4e may store the program 4h. The program 4h is a program executed by the CPU 4a or the graphics processing unit 4d. The program 4h stored in the login server 4 may include a job management program that increases the number of nodes for executing a job. Furthermore, the program 4h stored in the storing device 4e may include programs to be executed by the computing server 2 (computing nodes 20), for example.

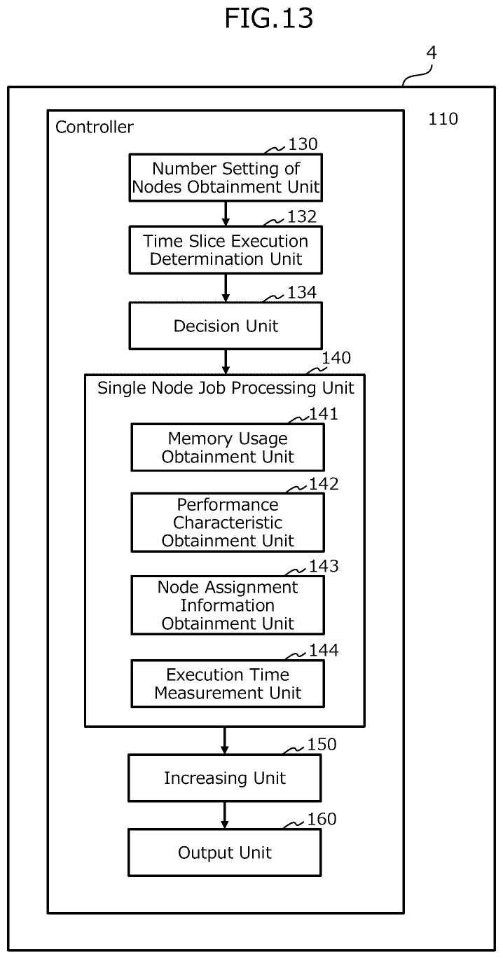

For example, the CPU 4a in the login server 4 can embody the functions as the login server 4 (for example, the controller 110 illustrated in FIG. 13) by deploying the program 4h stored in the storing device 4e into the memory 4b and executing the program 4h.

The IO device 4f may include either or both of an input device and an output device. Examples of the input device include a keyboard, a mouse, and a touch panel, for example. Examples of the output device include a monitor, a projector, and a printer, for example. The IO device 4f may also include a display device, such as a touch panel that integrates an input device and an output device. The output device may be connected to the graphics processing unit 4d.

The reader 4g is one example of a reader that reads information, such as data or a program recorded on a storage medium 4i. The reader 4g may include a connection terminal or device to which the storage medium 4i can be connected or inserted. Examples of the reader 4g include adapters that are compliant with standards, such as Universal Serial Bus (USB), drive devices that access recording disks, and card readers that access flash memory, such as SD cards, for example. It should be noted that the program 4h may be stored in the storage medium 4i, and the reader 4g may read the program 4h from the storage medium 4i and store the program 4h in the storing device 4e.

Examples of the storage medium 4i include, as an example, non-transitory computer-readable storage media such as magnetic/optical disks and flash memory. Examples of magnetic/optical disks may include, as an example, flexible disks, Compact Discs (CDs), Digital Versatile Discs (DVDs), Blu-ray discs, and Holographic Versatile Discs (HVDs). Examples of the flash memory include semiconductor memory devices such as USB memory and SD cards.

The HW configuration of the login server 4 described above is exemplary. Accordingly, HW components may be added or deleted (any block may be added or deleted, for example), divided, integrated in any combination, or buses may be added or deleted, in the login server 4 as appropriate. Additionally, the HW configurations of the computing nodes 20, the management server 3, and the console 5 may be similar to that illustrated in FIG. 3.

### (B) Description of One Embodiment

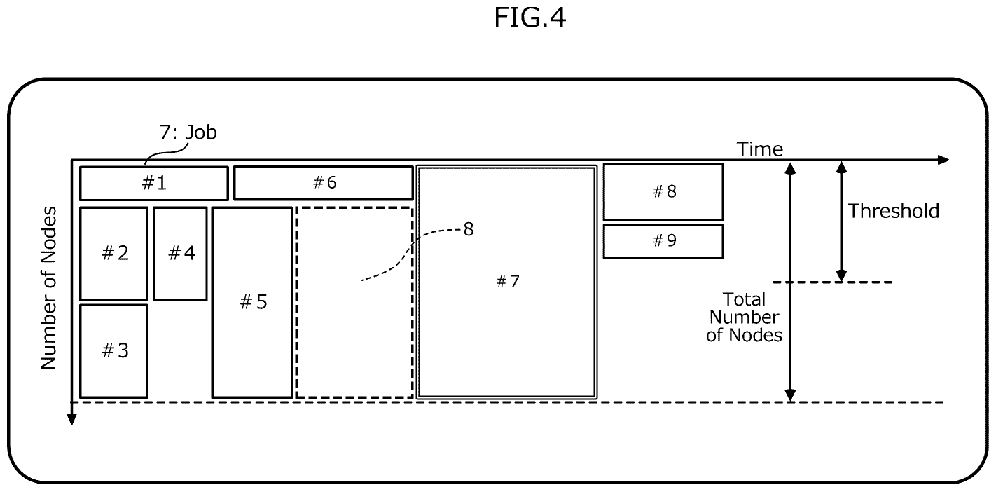

FIG. 4 is a diagram illustrating one example of the execution state of jobs 7 in non-time slice execution. As the plurality of jobs 7, jobs #1 to #9 are illustrated in FIG. 4. The length of the rectangle representing each job #1 to #9 in the horizontal direction f the diagram indicates the execution time of the job #1 to #9. The length of the rectangle representing each job #1 to #9 in the vertical direction of the diagram indicates the number of computing nodes 20 executing the job #1 to #9. Specifically, the length of each rectangle along the vertical axis of the diagram illustrated in FIG. 4 represents the number setting of nodes configured to be used for executing each job #1 to #9.

The management server 3 executes a scheduler to determine the execution order (operation order) of the jobs 7 by the computation program. The execution order may be determined based on the number settings of nodes configured to be used for executing the jobs 7 requested through the console 5, the priorities of the jobs 7, the number of nodes currently used on the computing server 2, and the number of nodes scheduled to be released. The execution order may be determined using a conventional scheduler function.

The scheduler secures the computer resources to be used in the computing server 2 based on the determined execution order and causes the computing server 2 to execute the computation program using the secured computer resources.

As illustrated in FIG. 4, in non-time slice execution, the scheduler basically executes the jobs 7 in the order in which they are submitted. Once a job 7 is started, it continues running while holding the allocated computer resources until the job 7 is completed. If a job 7 is submitted before other jobs 7 but cannot be executed immediately, the job 7 will remain in a waiting state until it can be executed.

Once a large-scale job, such as the job #7, that uses more nodes than a given number is started, it becomes difficult to start other processes before and during the execution of the large-scale job. Specifically, other jobs #8 and #9 are prevented from being executed before the job #7 is executed in order to secure nodes for executing the job #7. As a result, even though the job #7, the job #8, and the job #9 are queued, there is an idle state 8, preventing effective utilization of computer resources.

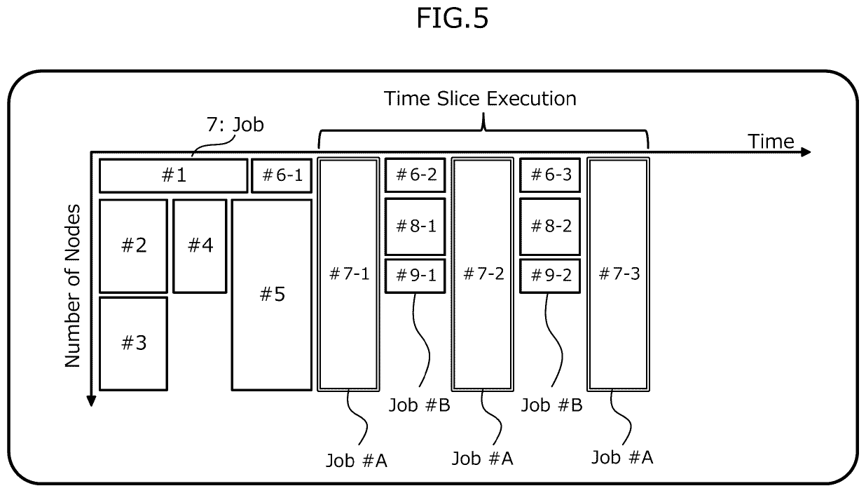

FIG. 5 is a diagram illustrating an example of the execution state of jobs in time slice execution according to a comparative example. A finely-grained time-division (time-slice) execution is performed for the job #7, which is a large-scale job, along with other jobs #6, #8, and #9. The job #7 is divided into jobs #7-1, #7-2, and #7-3 for execution. Similarly, the job #6 is divided into jobs #6-1, #6-2, and #6-3 for execution. The job #8 is divided into jobs #8-1 and #8-2 for execution, and the job #9 is divided into jobs #9-1 and #9-2 for execution. As a result, the job #7, which is a large-scale job, can be executed immediately, improving the utilization rate of the computing nodes. Large-scale jobs, such as jobs executed by all computing nodes 20 in the computing server 2 (the entire system), for example, can be executed smoothly at any time.

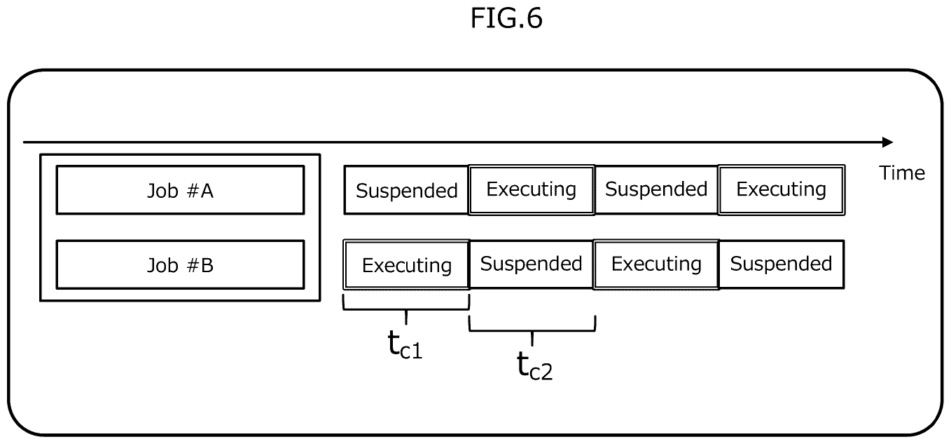

FIG. 6 is a diagram illustrating an example of switching of jobs 7 in time slice execution. In time slice execution, the computing server 2 including the plurality of computing nodes 20 executes a plurality of job groups, namely, a job #A and a job #B, on the same computer resources, by switching between them at divided time intervals. In the example of FIG. 4, the job #7 corresponds to the job #A, while the jobs #6, #8, and #9 correspond to the job #B. As illustrated in FIG. 5, the job #7 and the jobs #6, #8, and #9 are executed by switching between them at divided time intervals. In FIG. 5, the job #7 is executed as the jobs #7-1, #7-2, and #7-3 through time slice execution. Additionally, the jobs #8 and #9 are executed as the jobs #8-1 and #8-2, and the jobs #9-1 and #9-2, respectively, through time slice execution.

The switching time interval t_{c1} is the time duration during which the job #A is suspended and the job #B is executed, and the switching time interval t_{c2} is the time duration during which the job #B is suspended and the job #A is executed. The switching time intervals ta and t_{c2} may be between 0.1 seconds and 1 second, and tal and t_{c2} may be the same time interval t_{c}. In the following, to is defined as the switching time interval. Time slice execution is a process to cause at least a part of the plurality of computing nodes 20 to execute a plurality of jobs 7 by switching between the plurality of jobs 7 at divided switching time intervals t_{c} while maintaining data of the plurality of jobs 7 stored in a distributed manner in each memory 22 in the plurality of computing nodes 20. The switching between the job #A and the job #B is performed synchronously across the entire system (i.e., all computing nodes 20). As a result, it is possible to prevent a reduction in performance caused by communication latency due to synchronization misalignments.

The plurality of jobs #A and #B remain stored in the memory 22 in each computing node 20 in order to enable time slice execution of the jobs #A and #B on certain resources. Therefore, if the jobs #A and #B, which require high memory usage, are executed in a time-sliced manner, the execution may be impossible or cause a reduction in performance.

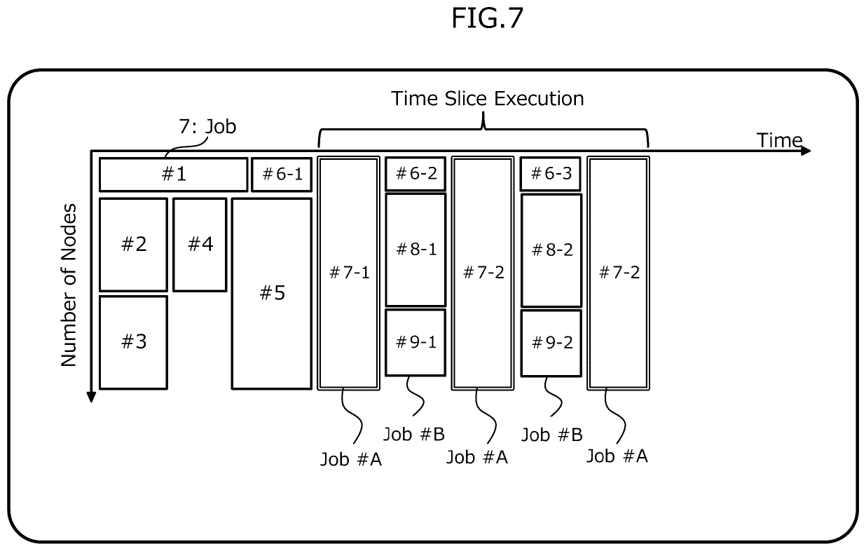

FIG. 7 is a diagram illustrating one example of the execution state of jobs 7 in time slice execution according to an embodiment of the present disclosure.

The CPU 4a in the login server 4 obtains the number setting of nodes from information of a program, a job script, and the like received from the console 5 for each job 7 submitted to the computing system 1 via the console 5. The number setting of nodes is the number of nodes configured to be used for executing a job 7. The CPU 4a determines whether or not the number setting of nodes is smaller than or equal to a threshold. In one example, the threshold is half of the total number of computing nodes 20 in the computing system 1.

In the case illustrated in FIG. 4, the number settings of nodes of the jobs #6, #8, #9, etc. (i.e., the vertical lengths of the corresponding rectangles) are determined to be smaller than or equal to the threshold. The number setting of nodes of the job #7, which is a large-scale job, is determined to be greater than the threshold. Based on the determination results, the CPU 4a increases the respective numbers of nodes to be used for executing the jobs #8 and #9. In FIG. 7, the numbers of nodes to be used for executing the jobs #8-1 and #8-2, which are divisions of the job #8 divided according to the switching time interval to, and the numbers of nodes to be used for executing the jobs #9-1 and #9-2, which are divisions of the job #9 divided according to the switching time interval t_{c}, are doubled from the corresponding number settings of nodes.

For the process of increasing the number of nodes to be used for executing a job 7 as described above, a wrapper program (i.e., a conversion program) may be provided in the job submission program installed on the login server 4. The CPU 4a increases the number of nodes in the arguments in the program and the job script by executing the wrapper program. The CPU 4a may send the program, the job script, and the like reflecting the increased number of nodes, to the management server 3 via the network device 6 or the like.

In this example, the login server 4 that executes the login process performs the processes, such as obtaining the number setting of nodes, deciding based on the threshold, and increasing the number of nodes. However, the embodiment of the present disclosure is not limited to this example. At least a part of these processes may be performed in one of information processing apparatuses provided between the console 5 and the management server 3. For example, depending on the specifications of the computing system 1, at least a part of these processes may be executed by one function of the management server 3. Alternatively, a server that performs at least a part of these processes may be provided separately from the login server 4 that executes the login process and the management server 3.

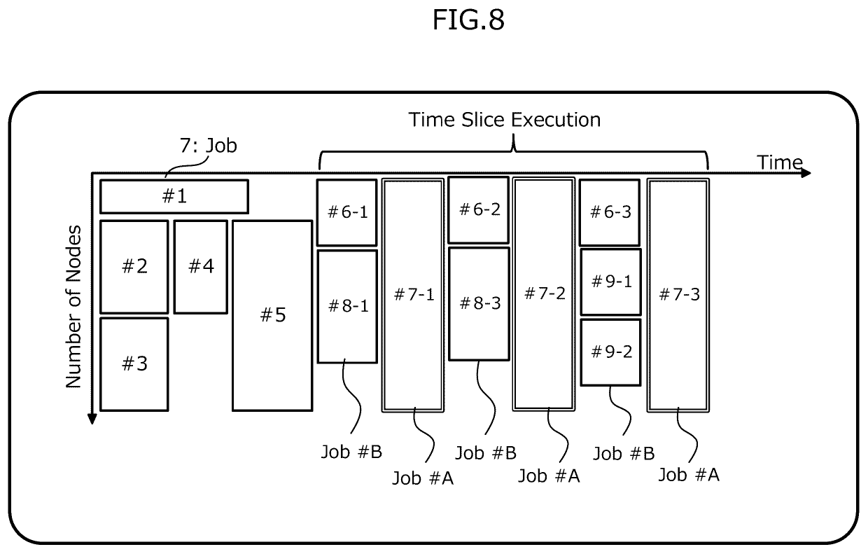

FIG. 8 is a diagram illustrating another example of the execution state of jobs 7 in time slice execution according to an embodiment of the present disclosure. In FIG. 7 described above, the job #6-1, which is a division of the job 6 divided according to the switching time interval to, has already been executed before the large-scale job #7, which is to be executed in a time-sliced manner, is started. Therefore, the login server 4 does not increase the number of nodes for executing the remaining job #6-2 and the job #6-3 because the jobs #6-2 and #6-3 will be assigned to the computing nodes 20 that is executing the job #6-1. Alternatively, as illustrated in FIG. 8, the login server 4 may increase the number of nodes used for executing the jobs #6-1, #6-2, and #6-3.

In the process illustrated in FIG. 8, when the CPU 4a in the login server 4 receives the job #6 and the job #7, etc., the CPU 4a may determine that the job #6 is to be executed in a time-sliced manner. For example, if the maximum execution times for the job #6 and the job #7 are specified in information provided via the console 5, the CPU 4a may determine that the job #6 is to be executed in a time-sliced manner based on that information and the information of the number setting of nodes. In this case, the CPU 4a may divide the job #6 to be executed in a time-sliced manner into jobs #6-1, #6-2, and #6-3 and increase the number of nodes. Since the job #6-1 cannot be executed in parallel with the job #5 due to the increased number of nodes, the job #6-1 is executed after the job #5 is completed. Specifically, to prevent the job #5 and the job #6-1 from being executed concurrently, the job #6-1 is restricted from being executed until the preceding job #5 is completed. This restriction may be achieved, for example, by establishing dependencies between the jobs 7 using the afterany option in Slurm.

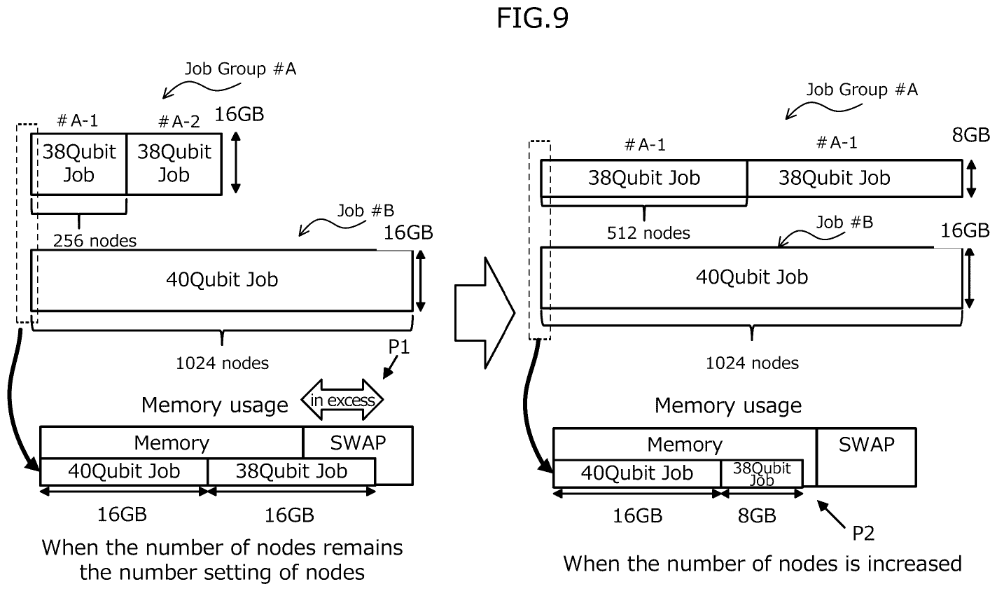

FIG. 9 is a diagram illustrating the relationship between the number of computing nodes executing jobs 7 and memory usage. In the embodiment illustrated in FIG. 7 and FIG. 8, the number of computing nodes used for executing a job #7 to be executed in a time-sliced manner is increased by changing the number of nodes and reassigning nodes accordingly so that the memory usage does not exceed the memory capacity of the memory 22.

As described above, in parallel applications where a plurality of computing nodes 20 operate in parallel to perform calculations, data is stored in a distributed manner in the memory 22 of each computing node 20. In cases where the data size of jobs 7 remains constant, the memory usage per node can be reduced by increasing the number of computing nodes. The process illustrated in FIG. 7 and FIG. 8 is preferably used for parallel applications where the region to be computed is divided into a plurality of subregions, and each computing node 20 performs a calculation on the assigned subregion. In one example, such parallel applications include weather simulations and quantum simulations. A quantum simulation is a technique that simulates the state of quantum bits (qubits) as state vectors stored in the memory 22. Referring to FIG. 9, a quantum simulation will be described as an example.

In the example illustrated in FIG. 9, the required memory usage doubles for each additional quantum bit to be simulated. Here, in the example, the total number of computing nodes 20 in the entire computing system 1 is 1024+α. α may correspond to the number of extra computing nodes 20 provided as a reserve in case of a failure of computing nodes 20. For example, the total number of computing nodes 20 may be 1056.

In one example, if a simulation of 40 quantum bits is executed using all computing nodes 20, the total memory usage across all nodes amounts to 16 TiB. When the total number of computing nodes 20 is 1024+α, the memory 22 per node holds 16 TiB divided by (1024+α) of data, which equals 16 GiB. In this case, the number of quantum bits to be simulated per node is 40 quantum bits divided by (1024+α), which equals 30 quantum bits.

If the number of computing nodes 20 for executing the job 7 is doubled while maintaining the number of quantum bits to be simulated, the memory usage per node is halved. For example, a computation in which the number of quantum bits to be simulated is 30 quantum bits per node is changed to a computation in which the number of quantum bits to be simulated is 30 quantum bits per two nodes, the memory 22 only needs to hold 8 GiB of data per node. The computation in which the number of quantum bits to be simulated is 30 quantum bits per two nodes corresponds to a computation in which the number of quantum bits to be simulated is 30 quantum bits divided by 2, that is, 29 quantum bits, per node.

In FIG. 9, a job group #A and a job #B are submitted as jobs to be executed in a time-sliced manner. The job group #A includes a job #A-1 and a job #A-2. In one example, the job #A-1 and the job #A-2 may correspond to the job #6 in FIG. 8 (which is divided into the jobs #6-1 to #6-3 according to the switching time interval t_{c}), the job #8 (which is divided into the jobs #8-1 to #8-2 according to the switching time interval t_{c}), or other jobs. In one example, the job #B may correspond to the job #7 (which is divided into the jobs #7-1 to #7-3 according to the switching time interval t_{c}) or other jobs.

In the example illustrated in FIG. 9, as illustrated in the left diagram, the job #A-1 and the job #A-2 are each 38-quantum bit jobs (38-Qubit jobs) in which the number of quantum bits to be simulated is 38 quantum bits, and the number settings of nodes are 256 nodes each. The 38-quantum bit jobs (38-Qubit jobs) are assigned to 256 nodes. In this case, since the number of quantum bits to be simulated per node is the same as that when a simulation of 40 quantum bits is performed by all computing nodes 20 (1024 nodes+α), the memory 22 holds 16 GiB of data per node. Similarly, for the job #B, the memory 22 holds 16 GiB of data per node.

Therefore, when the job group #A and the job #B are executed in a time-sliced manner, the memory 22 holds 32 GiB of data per node. As a result, since the memory usage exceeds the memory capacity (see the arrow P1), a memory swap operation (SWAP) is performed to exchange data between an area in the memory 22 and an equally sized area in an external storage device, leading to a decrease in system performance.

The CPU 4a determines whether or not the respective number settings of nodes for the job #A-1 and the job #A-2 are smaller than or equal to the threshold. The threshold may be half of the total number of computing nodes 20 in the computing system 1. The respective number settings of nodes for the job #A-1 and the job #A-2 are determined to be smaller than or equal to the threshold. The number setting of nodes for the job #B is determined to be greater than the threshold. Therefore, based on the determination results, the CPU 4a increases the numbers of nodes used for executing the job #A-1 and the job #A-2. In the right diagram of FIG. 9, the numbers of nodes used for executing the job #A-1 and the job #A-2 is doubled from the previous number settings of nodes. As a result, the 38-quantum bit jobs (38-Qubit jobs) are assigned to 512 nodes, and the memory usage of the memory 22 per node for the job #A-1 and the job #A-2 is reduced to 8 GiB, which is half of the previous value. Thus, even when the job group #A and the job #B are executed in a time-sliced manner, the memory 22 only needs to hold 24 GiB of data per node. As a result, the memory usage remains within the memory capacity (see the arrow P2), allowing for memory operations on the memory 22. Since memory swap operations (SWAPs) are avoided, the decrease in system performance is prevented.

However, if the number setting of nodes for the job #A-1 or other jobs is one, doubling the number of nodes for executing the jobs #A-1 to two nodes will cause communications between multiple computing nodes 20, and an additional process may be performed. The process when the number of nodes for the job 7 is one will be described later.

Furthermore, in FIG. 9, if both the job #A and the job #B are large-scale jobs having number settings of nodes greater than the threshold (such as the 40-quantum bit job in FIG. 9), the CPU 4a executes a process to prevent the two large-scale jobs from operating in parallel. In one example, the job #B is restricted from being executed until the preceding job #A is completed. This restriction may be achieved, for example, by establishing dependencies between jobs 7 using the afterany option in Slurm.

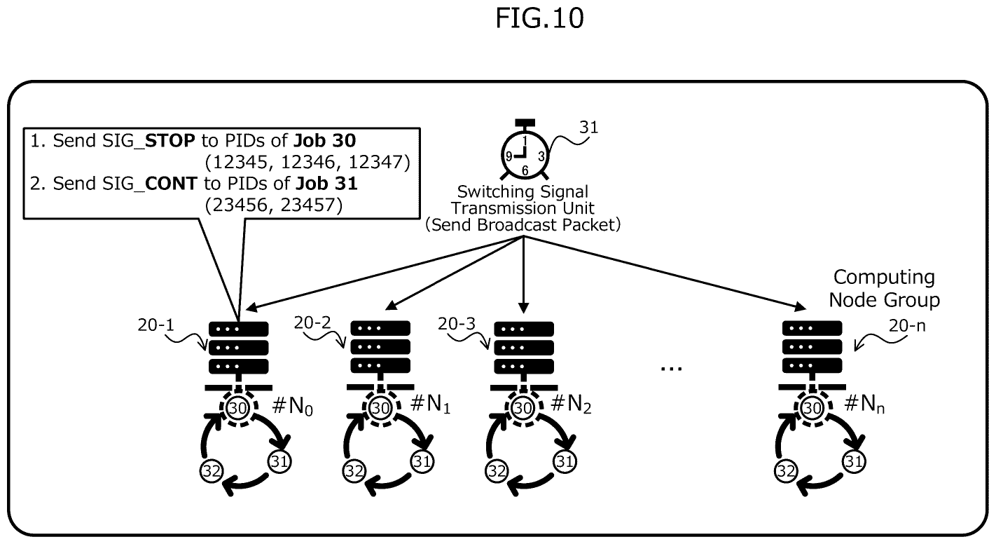

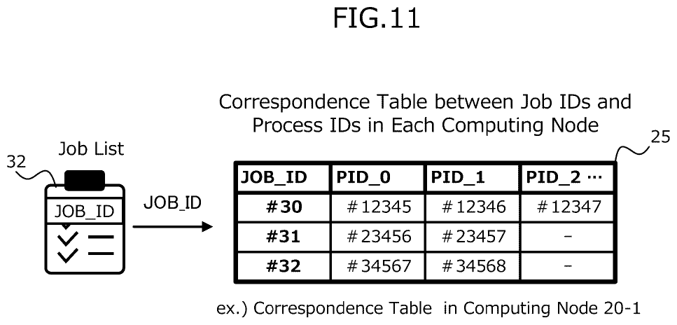

FIG. 10 is a diagram illustrating one example of a signal transmission process for time slice execution. FIG. 11 is one example of a correspondence table 25 that associates job IDs with process IDs in each computing node 20. FIG. 11 illustrates the correspondence table 25 in the computing node 20-1. Similar correspondence tables 25 are also generated in other computing nodes 20.

In one example, when time slice execution is performed, the management server 3 executes the process illustrated in FIG. 10 based on the arguments of the program and contents in the job script modified by the wrapper program provided in the login server 4 or the like.

The management server 3 may include a switching signal transmission unit 31. The switching signal transmission unit 31 broadcasts a switching signal to the computing nodes 20-1 to 20-n as broadcast packets, to stop the job with the job ID of 30 and cause the next job with the job ID of 31 to be executed. In other words, the switching signal transmission unit 31 notifies each computing node 20 of the job ID of the job to be executed next. The switching signal transmission unit 31 has a job list 32 in which jobs 7 to be executed are listed. Each computing node 20 generates a correspondence table 25 that associates each job ID in the job list 32 with the corresponding process ID. In response to receiving a switching signal indicating the job ID of the next job to be executed, the processor in the computing node 20 refers to the correspondence table 25 and sends a STOP signal to stop the corresponding processes or a CONT signal to resume the process. The STOP signal and CONT signal may be based on kernel software interrupt functions used to notify processes or process groups of various events. It should be noted that FIG. 10 and FIG. 11 illustrate one example of the signal transmission process for time slice execution, and the process is not limited to the one illustrated in FIG. 10 and FIG. 11.

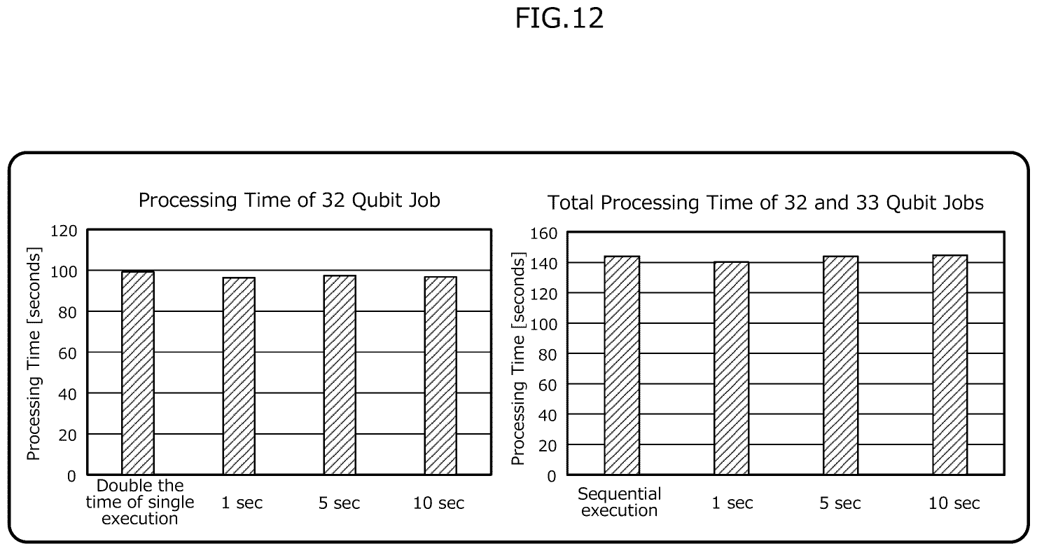

FIG. 12 is a diagram illustrating experimental results regarding the effect of time slice execution on processing time. The left diagram in FIG. 12 illustrates the processing time when two 32-quantum bit jobs were executed in a time-sliced manner in the computing system 1 where the total number of computing nodes 20 was eight. When time slice execution was performed by varying the switching time interval tc to 1 second, 5 seconds, or 10 seconds, the processing time was not increased compared to twice the processing time when a 32-quantum bit job was executed alone (that is, when two 32-quantum bit jobs were executed sequentially).

Similarly, the right diagram in FIG. 12 illustrates the processing time when a 32-quantum bit job and a 33-quantum bit job were executed in a time-sliced manner in the computing system 1 where the total number of computing nodes 20 was eight. When time slice execution was performed by varying the switching time interval t_{c} to 1 second, 5 seconds, or 10 seconds, the processing time was not increased compared to the processing time when a 32-quantum bit job and a 33-quantum bit job were executed sequentially. Thus, time slice execution did not cause a reduction in performance due to overhead.

### (C) Example of Functional Configuration of One Embodiment

FIG. 13 is a block diagram illustrating an example of the functional configuration of the login server 4 illustrated in FIG. 1. The login server 4 may include a controller 110. It is to be noted that the controller 110 is the configuration in view of the process of increasing the number of computing nodes by the login server 4. For example, the controller 110 may be provided in the login server 4 as a function achieved by executing a wrapper program (i.e., a conversion program) or may be provided in the management server 3 as a part of the functions of the scheduler. The controller 110 may include, as an example, a

number setting of nodes obtainment unit 130, a time slice execution determination unit 132, a decision unit 134, a single node job processing unit 140, an increasing unit 150, and an output unit 160. The single node job processing unit 140 may include, as an example, a memory usage obtainment unit 141, a performance characteristic obtainment unit 142, a node assignment information obtainment unit 143, and an execution time measurement unit 144.

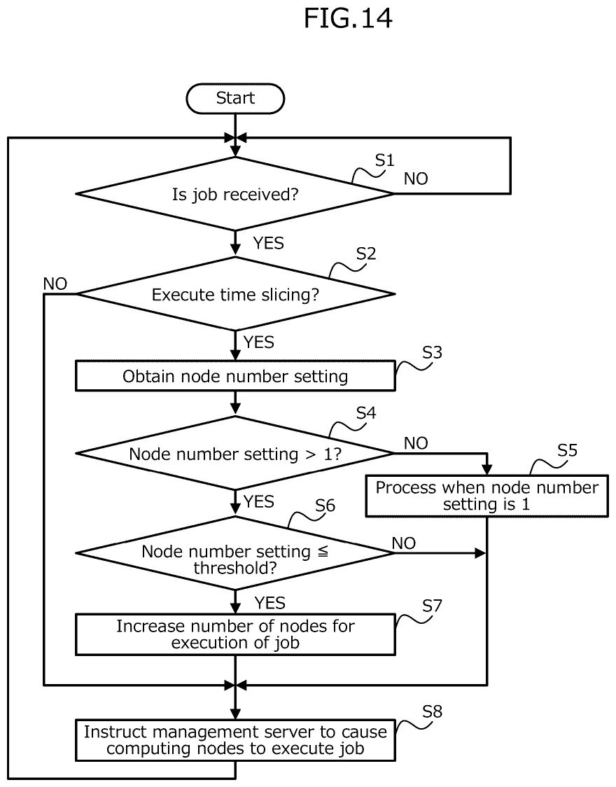

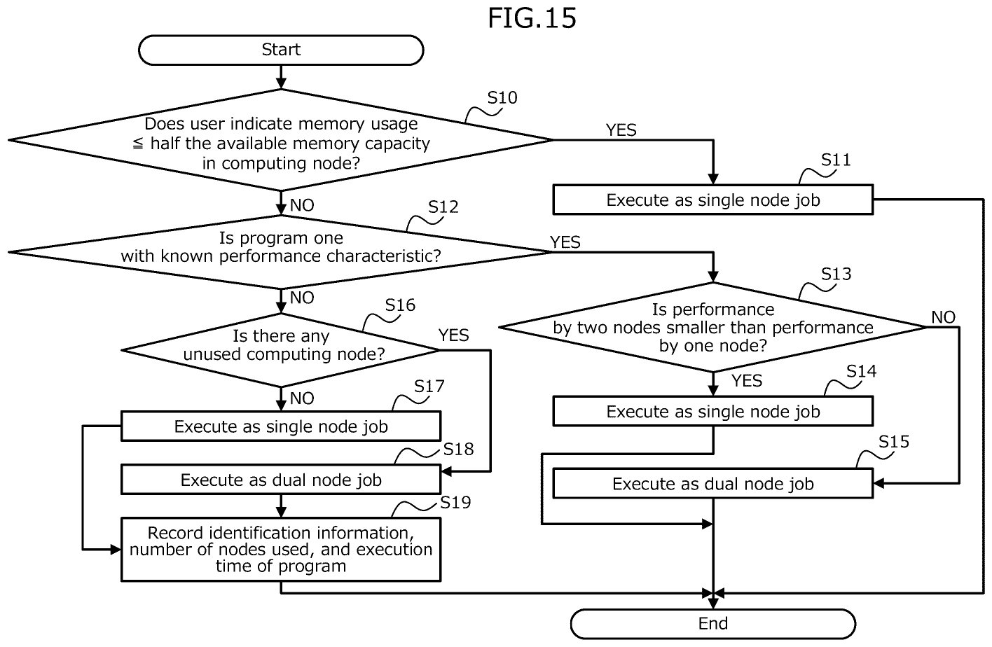

In the following, the functional blocks 130 to 160 included in the controller 110 illustrated in FIG. 13 will be described with reference to the examples of operations illustrated in FIG. 14 and FIG. 15.

### (D) Examples of Operations

FIG. 14 is a flowchart illustrating one example of a job management process in an embodiment of the present disclosure. The process in FIG. 14 may be executed by the login server 4. Alternatively, another apparatus may execute the process instead of the login server 4.

The controller 110 waits until it receives jobs 7 from the console 5 (see the NO route of Step S1). For example, the controller 110 receives programs, job scripts, and the like related to jobs 7 from the console 5. In response to the controller 110 receiving jobs 7 from the console 5 (see the YES route of Step S1), the time slice execution determination unit 132 determines whether or not the received plurality of jobs 7 are to be performed in a time-sliced manner (Step S2). If the maximum execution times for the respective job 7 are specified in information provided via the console 5, the time slice execution determination unit 132 may determine that the respective jobs are to be executed in a time-sliced manner based on information of the maximum execution times and information of the number setting of nodes. However, if the maximum execution time is not specified, the processing in Step S2 may be omitted.

Time slice execution is a process to cause at least a part of the plurality of computing nodes 20 to execute a plurality of jobs 7 by switching between the plurality of jobs 7 at divided switching time intervals t. while maintaining data of the plurality of jobs 7 stored in a distributed manner in each memory 22 in the plurality of computing nodes 20.

If the jobs are not to be executed in a time-sliced manner (see the NO route of Step S2), the process proceeds to Step S8. If the jobs are to be executed in a time-sliced manner (see the YES route of Step S2), the process proceeds to Step S3.

The number setting of nodes obtainment unit 130 obtains, for each job submitted to the computing system 1, the number setting of nodes configured to be used for executing that job 7 (Step S3).

The decision unit 134 determines whether or not the number setting of nodes is more than one (Step S4). If the number setting of nodes is not more than one, i.e., is one (see the NO route of Step S4), the process proceeds to Step S5. The single node job processing unit 140 executes the process for cases where the number setting of nodes is one (Step S5), and the process proceeds to Step S8.

If the determination result in Step S4 indicates that the number setting of nodes is more than one (see the YES route of Step S4), the decision unit 134 determines whether or not the number setting of nodes is smaller than or equal to a threshold (Step S6). In one example, the threshold may be 1/N of the total number of computing nodes 20 in the computing system 1 (where N is a natural number of 2 or greater). In particular, the threshold may be half of the total number of computing nodes 20 in the computing system 1.

If the number setting of nodes is smaller than or equal to the threshold (see the YES route of Step S6), the increasing unit 150 increases the number of computing nodes used for executing the job 7 within the total number of computing nodes 20 in the computing system 1 (Step S7). If the threshold is 1/N of the total number of computing nodes 20, the increasing unit 150 may multiply the number setting of nodes by N. In particular, if the threshold is 1/2 of the total number of computing nodes 20, the increasing unit 150 may double the number setting of nodes.

The increasing unit 150 may execute a process to increase the number of nodes in the arguments in the program and the job script.

If the number setting of nodes is greater than the threshold (see the NO route of Step S6), the process proceeds to Step S8.

The output unit 160 instructs the management server 3 to cause computing nodes 20 to execute the plurality of jobs 7 (Step S8). If the increasing unit 150 has generated a program, job script, and the like reflecting the increased number of nodes, the output unit 160 sends the modified program and job script to the management server 3. After Step S8 is completed, the process returns to Step S1.

If a job 7 that is originally executed on one node is run on two nodes, communication overhead due to parallelization may occur, resulting in a significant reduction in performance. For example, if a job 7 is modified from a four-node execution to an eight-node execution, increasing the number of nodes only causes an increase in the communication volume because communications between the multiple nodes have already been established in the four-node execution. On the contrary, modifying a job 7 from a one-node execution to a two-node execution is a major change because node-to-node communications will be newly introduced.

FIG. 15 is a flowchart illustrating one example of the process when the number setting of nodes is one in an embodiment of the present disclosure.

If the decision unit 134 determines that the number setting of nodes for the job 7 is one, in other words, the job 7 is determined to be a single-node usage job, the process illustrated in FIG. 15 may be executed.

The memory usage obtainment unit 141 determines whether there is information provided by the user as to whether or not the memory usage of the job 7 when the job 7 is submitted is less than or equal to half of the memory capacity of the memory 22 (installed memory capacity), i.e., the amount of available memory, in the computing node 20.

If the information provided by the user, i.e., information provided via the console 5, has indicated that the memory usage of the job 7 is less than or equal to half of the memory capacity of the memory 22 in the computing node 20 (see the YES route of Step S10), the process proceeds to Step S11. The single node job processing unit 140 maintains the number setting of nodes of the job 7 at one. In other words, the controller 110 causes a single computing node 20 to execute the job 7 as a single-node usage job (Step S11). Subsequently, the controller 110 ends the process.

If no information provided by the user has indicated that the memory usage of the job 7 is less than or equal to half of the memory capacity of the memory 22 in the computing node 20 (see the NO route of Step S10), the process proceeds to Step S12.

In Step S12, the performance characteristic obtainment unit 142 determines whether or not the performance characteristic 9 (scalability information) of the program executing the job 7 is known. Furthermore, if the performance characteristic 9 of the program executing the job 7 is available, the performance characteristic obtainment unit 142 obtains the performance characteristic 9. The performance characteristic 9 includes performance information in the case where the number of computing nodes 20 is increased and decreased. The performance information may be the processing speed and the processing time.

If the performance characteristic 9 of the program executing the job 7 is known (see the YES route of Step S12), the performance characteristic obtainment unit 142 determines whether or not the performance when the job 7 is executed on two nodes will be lower than the performance when the job 7 is executed on one node (Step S13).

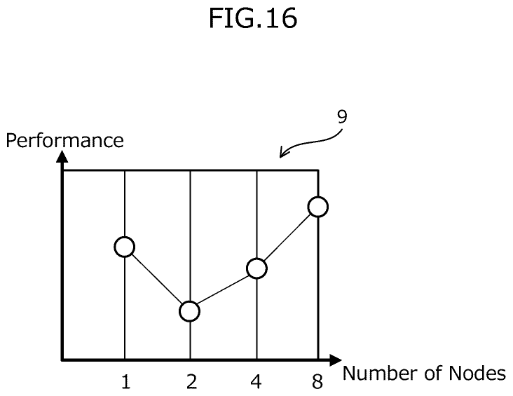

FIG. 16 is a diagram illustrating one example of the performance characteristic 9. As illustrated in FIG. 16, the performance characteristic 9 may include processing speed information for each number of nodes to run the job 7. When the job 7 that is originally executed on one node is executed on two nodes, communication overhead due to parallelization may occur, which may significantly reduce the processing speed. The performance characteristic 9 includes performance information when the job 7 is executed on one computing node 20 and when the job 7 is executed on two computing nodes 20. If the performance when the job 7 is executed on two nodes will be lower than the performance when the job 7 is executed on one node (see the YES route of Step S13), the controller 110 causes one computing node 20 to execute the job 7 as a single-node usage job (Step S14). Subsequently, the controller 110 ends the process. If the performance when the job 7 is executed on two nodes will not be lower than the performance when the job 7 is executed on one node (see the NO route of Step S13), the controller 110 causes two computing nodes 20 to execute the job 7 as a dual-node usage job (Step S15). Subsequently, the controller 110 ends the process.

The processes in Steps S12 to S15 are one example of the process of changing the number of computing nodes based on the performance characteristic of a job 7 of interest for each number of the computing nodes.

If the program executing the job 7 has no known performance characteristic 9 (see the NO route of Step S12), the process proceeds to Step S16.

The node assignment information obtainment unit 143 obtains node assignment information. The node assignment information may include whether or not all computing nodes 20 have jobs 7 assigned thereto. The controller 110 determines whether or not there is any unused computing node 20 (Step S16). If all computing nodes 20 have jobs 7 assigned thereto (see the NO route of Step S16), the controller 110 causes one computing node 20 to execute the job 7 as a single-node usage job (Step S17). If there is any unused computing node 20 (see the YES route of Step S16), the controller 110 causes two computing nodes 20 to execute the job 7 as a dual-node usage job (Step S18).

As a result of the processes in Steps S17 and S18, the execution time measurement unit 144 records the identification information of the programs to execute the jobs 7, the number of nodes used, and the execution time (processing time) (Step S19). The measurement results of execution time by the execution time measurement unit 144 are stored in an execution time storage unit 124. The controller 110 may calculate the performance characteristic 9 based on the measurement results of execution time. Subsequently, the controller 110 ends the process.

### (E) Effects of One Embodiment

According to the technique according to one embodiment, when time slice execution is performed in the computing system 1, the controller 110 obtains, for each of a plurality of jobs 7 submitted to the computing system 1, a number setting of nodes configured to be used for the execution of that job 7. The controller 110 determines whether or not the number setting of nodes is smaller than or equal to a threshold. The controller 110 increases, for at least a part of the plurality of jobs 7 of which number setting of nodes is smaller than or equal to the threshold, the number of computing nodes used for the execution within the total number of computing nodes 20 in the computing system 1.

By increasing the number of computing nodes for executing the jobs 7, the amount of data held per computing node is reduced, which prevents memory shortage even when time slice execution is performed.

The threshold is half of the total number of computing nodes 20, and the increasing the number of the computing nodes within the total number of computing nodes includes doubling the number of computing nodes.

As a result, by executing the jobs 7 that fit within half the system scale using twice the number of nodes, it is ensured that time slice execution remains available at any time.

The process of increasing the number of computing nodes within the total number of computing nodes 20 is executed by the controller 110 when the number setting of nodes is smaller than or equal to the threshold and greater than one.

As a result, it is possible to prevent the occurrence of communication overhead caused by executing a job 7 that is executed on one node, on two nodes.

The number of computing nodes is changed based on the performance characteristic of a job 7 of interest for each number of the computing nodes.

As a result, the number of nodes for executing the job 7 is dynamically adjusted according to the performance characteristic 9 of the program, which helps maintaining an optimal state.

In one aspect, the present disclosure can prevent memory shortage in each computing node when a plurality of jobs are executed concurrently in a system having a plurality of computing nodes.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a job management program that causes a computer to execute a process comprising:
obtaining, for each of the plurality of jobs submitted to a system comprising a plurality of computing nodes, a number setting of nodes configured to be used for an execution of the each job;
determining whether or not the number setting of nodes is smaller than or equal to a threshold;
increasing, for at least a part of one or more jobs of which number setting of nodes is smaller than or equal to the threshold, a number of the computing nodes used for the execution within a total number of computing nodes in the system; and
causing at least a part of the plurality of computing nodes to execute the plurality of jobs by switching between the plurality of jobs at divided time intervals while maintaining data of the plurality of jobs stored in a distributed manner in a memory in each node of the plurality of computing nodes in the system.

2. The non-transitory computer-readable recording medium according to claim 1, wherein the threshold is half of the total number of computing nodes, and
increasing the number of the computing nodes within the total number of computing nodes comprises doubling the number of computing nodes.

3. The non-transitory computer-readable recording medium according to claim 1, the process further comprising increasing the number of the computing nodes within the total number of computing nodes when the number setting of nodes is smaller than or equal to the threshold and is greater than one.

4. The non-transitory computer-readable recording medium according to claim 1, the process further comprising changing the number of computing nodes based on a performance characteristic of a job of interest for each number of the computing nodes.

5. A computer-implemented job management method comprising:
obtaining, for each of the plurality of jobs submitted to a system comprising a plurality of computing nodes, a number setting of nodes configured to be used for an execution of the each job;
determining whether or not the number setting of nodes is smaller than or equal to a threshold;
increasing, for at least a part of one or more jobs of which number setting of nodes is smaller than or equal to the threshold, a number of the computing nodes used for the execution within a total number of computing nodes in the system; and
causing at least a part of the plurality of computing nodes to execute the plurality of jobs by switching between the plurality of jobs at divided time intervals while maintaining data of the plurality of jobs stored in a distributed manner in a memory in each node of the plurality of computing nodes in the system.

6. The computer-implemented job management method according to claim 5, wherein the threshold is half of the total number of computing nodes, and
increasing the number of the computing nodes within the total number of computing nodes comprises doubling the number of computing nodes.

7. The computer-implemented job management method according to claim 5, further comprising increasing the number of the computing nodes within the total number of computing nodes when the number setting of nodes is smaller than or equal to the threshold and is greater than one.

8. The job management method according to claim 5, further comprising changing the number of computing nodes based on a performance characteristic of a job of interest for each number of the computing nodes.

9. An information processing apparatus comprising:
a memory; and
a processor coupled to the memory, the processor being configured to perform a process comprising:
obtaining, for each of the plurality of jobs submitted to a system comprising a plurality of computing nodes, a number setting of nodes configured to be used for an execution of the each job;
determining whether or not the number setting of nodes is smaller than or equal to a threshold;
increasing, for at least a part of one or more jobs of which number setting of nodes is smaller than or equal to the threshold, a number of the computing nodes used for the execution within a total number of computing nodes in the system; and
causing at least a part of the plurality of computing nodes to execute the plurality of jobs by switching between the plurality of jobs at divided time intervals while maintaining data of the plurality of jobs stored in a distributed manner in a memory in each node of the plurality of computing nodes in the system.

10. The information processing apparatus according to claim 9, wherein the threshold is half of the total number of computing nodes, and
increasing the number of the computing nodes within the total number of computing nodes comprises doubling the number of computing nodes.

11. The information processing apparatus according to claim 9, the process further comprising increasing the number of the computing nodes within the total number of computing nodes when the number setting of nodes is smaller than or equal to the threshold and is greater than one.

12. The information processing apparatus according to claim 9, the process further comprising changing the number of computing nodes based on a performance characteristic of a job of interest for each number of the computing nodes.
